(19) United States
(12) Patent Application Publication
(10) Pub. No.: US 2026/0347169 A1
(43) Pub. Date: Nov. 5, 2026

(54) FLUID DOSING DEVICE AND METHOD

(71) Applicant: Dema Engineering Company, St. Louis, MO (US)

(72) Inventors: Sone Justin Chan, Maryland Heights, MO (US); James Michael Schlueter, Defiance, MO (US)

(21) Appl. No.: 19/662,436

(22) Filed: Apr. 29, 2026

Related U.S. Application Data
(60) Provisional application No. 63/798,092, filed on May 1, 2025.

(51) Int. Cl. B67D 7/84; B67D 7/02

(52) U.S. Cl. CPC B67D 7/84; B67D 7/0205

(57) ABSTRACT

A fluid dosing device includes a surface-mountable base having a base inlet and a base outlet, the base inlet in fluid communication with a bulk fluid source and the base outlet in fluid communication with a desired fluid destination; a pump assembly having a pump inlet and a pump outlet, the pump inlet in selective fluid communication with the base inlet and the pump outlet in selective fluid communication with the base outlet when the pump assembly is engaged with the base; and a selectively releasing coupling between the base and the pump assembly configured for removal of the pump assembly from the base without removal of the base from a supporting surface. An associated method of servicing a fluid dosing device is also disclosed.

### CROSS REFERENCES

This application claims priority to U.S. Provisional No. 63/798,092, filed May 1, 2025, the disclosure of which is hereby incorporated by reference herein in its entirety.

### TECHNICAL FIELD

The present disclosure relates generally to a fluid dosing device used to dispense bulk fluids, for example, chemicals, into machines or reservoirs used to clean various materials, and more particularly, to a device and method that allows for ease of service.

### BACKGROUND

Dosing chemical dispensers are known in the art and generally allow users to dose bulk chemical into machines, reservoirs, or spray bottles that are used for cleaning. For most dosing chemical dispensers, servicing of the device will be required during the operational life of the device. Some of the reasons for service of the device may include, but are not limited to the device losing the ability to dose chemicals or the device may exhibit external leaking.

### SUMMARY

According to a first aspect of the present disclosure, there is provided a fluid dosing device that includes a surface-mountable base having a base inlet and a base outlet, wherein the base inlet is in fluid communication with a bulk fluid source and the base outlet is in fluid communication with a desired fluid destination; a pump assembly having a pump inlet and a pump outlet, wherein the pump inlet is configured for selective fluid communication with the base inlet and the pump outlet is configured for selective fluid communication with the base outlet, the pump assembly being configured to draw fluid from the bulk fluid source through the base inlet and into the pump inlet and to expel fluid out of the pump outlet to the base outlet when the pump assembly is engaged with the base; and a selectively releasing coupling between the base and the pump assembly configured for removal of the pump assembly from the base without removal of the base from a supporting surface of the base.

According to another aspect of the present disclosure, the base includes an inlet receiver in fluid communication with the base inlet and an outlet receiver in fluid communication with the base outlet; wherein the inlet receiver is configured to engage the pump inlet to form an inlet fluid path between the pump inlet and the base inlet; and wherein the outlet receiver is configured to engage the pump outlet to form an outlet fluid path between the pump outlet and the base outlet.

According to another aspect of the present disclosure, the base further includes an outlet conduit passageway fluidly connecting the outlet receiver and the base outlet and an inlet conduit passageway fluidly connecting the inlet receiver and the base inlet.

According to another aspect of the present disclosure, the selectively removable coupling between the base and the pump assembly includes a manually releasable and engageable fastener.

According to another aspect of the present disclosure, the pump assembly includes one or more alignment slots and the base further comprises a mounting collar having one or more alignment ribs corresponding to the one or more alignment slots, and wherein the one or more alignment slots are configured on the pump assembly and the one or more alignment ribs are configured on the mounting collar to align the pump inlet with the base inlet and align the pump outlet with the base outlet when the one or more alignment slots are aligned with the one or more alignment ribs.

According to another aspect of the present disclosure, the one or more alignment ribs are configured on an internal surface of the mounting collar.

According to another aspect of the present disclosure, the pump assembly includes one or more alignment slots and the base further comprises a mounting collar having one or more alignment ribs corresponding to the one or more alignment slots, and wherein the one or more alignment slots are configured on the pump assembly and the one or more alignment ribs are configured on the mounting collar to align the pump inlet with the inlet receiver and align the pump outlet with the outlet receiver when the one or more alignment slots are aligned with the one or more alignment ribs.

According to another aspect of the present disclosure, the one or more alignment ribs are configured on an internal surface of the mounting collar.

According to another aspect of the present disclosure, the base further includes a mounting collar configured to receive at least a portion of the pump assembly adjacent to the pump inlet and the pump outlet.

According to another aspect of the present disclosure, at least a portion of the selectively releasable coupling is configured on the mounting collar.

According to another aspect of the present disclosure, at least a first portion of the selectively releasable coupling is configured on at least one of the pump inlet and pump outlet and at least a second portion of the selectively releasable coupling is configured on at least one of the inlet receiver and the outlet receiver.

According to another aspect of the present disclosure, the fluid dosing device includes a cover assembly selectively connectable to the base and configured to enclose the pump assembly.

According to another aspect of the present disclosure, there is provided a method of servicing a fluid dosing device that includes the steps of providing a fluid dosing device having: a surface-mountable base having a base inlet and a base outlet, wherein the base inlet is in fluid communication with a bulk fluid source and the base outlet is in fluid communication with a desired fluid destination; a pump assembly having a pump inlet and a pump outlet, wherein the pump inlet is in selective fluid communication with the base inlet and the pump outlet is in selective fluid communication with the base outlet, the pump assembly being configured to draw fluid from the bulk fluid source through the base inlet and into the pump inlet an to expel fluid out of the pump outlet to the base outlet when the pump assembly is engaged with the base; and a selectively releasable coupling between the base and the pump assembly configured for removal of the pump assembly from the base without removal of the base from a supporting surface of the base; disengaging the selectively releasable coupling; removing the pump assembly from the base; providing a replacement pump assembly also having a pump inlet and a pump outlet; fluidly connecting the pump inlet of the replacement pump assembly with the base inlet and fluidly connecting the pump outlet of the replacement pump assembly with the base outlet; re-engaging the selectively releasable coupling to secure the replacement pump assembly to the base; and wherein the base remains secured to a supporting surface during removal of the pump assembly and installation of the replacement pump assembly.

According to another aspect of the present disclosure, the step of fluidly connecting the pump inlet of the replacement pump assembly with the base inlet and fluidly connecting the pump outlet of the replacement pump assembly with the base outlet includes engaging the pump inlet of the replacement pump with an inlet receiver to form an inlet fluid path between the pump inlet and the base inlet and engaging the pump outlet with an outlet receiver to form an outlet fluid path between the pump outlet and the base outlet.

According to another aspect of the present disclosure, the method includes the step of aligning one or more alignment slots on the pump assembly with one or more alignment ribs on a mounting collar of the base as the pump assembly is inserted into the mounting collar prior to the step of fluidly connecting the pump inlet of the replacement pump assembly with the base inlet and fluidly connecting the pump outlet of the replacement pump assembly with the base outlet.

According to another aspect of the present disclosure, the method includes the step of aligning the one or more alignment slots with the one or more alignment ribs as the pump assembly is inserted into the mounting collar prior to the step of engaging the pump inlet of the replacement pump with the inlet receiver to form an inlet fluid path between the pump inlet and the base inlet and engaging the pump outlet with the outlet receiver to form an outlet fluid path between the pump outlet and the base outlet.

Thus, the combination of elements allows a fluid dosing device to be serviced with minimal labor and with minimal exposure of bulk fluid to the service person. These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 is a perspective view of an embodiment of a fluid dispensing device in accordance with the teaching of the present disclosure.

FIG. 2 is a perspective view of the embodiment of FIG. 1 with a cover assembly removed.

FIG. 3 is a perspective view of a base of the embodiment of FIG. 1.

FIG. 4 is a perspective view of a pump assembly of the embodiment of FIG. 1.

FIG. 5 is a section view of the base of FIG. 3.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The methods, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

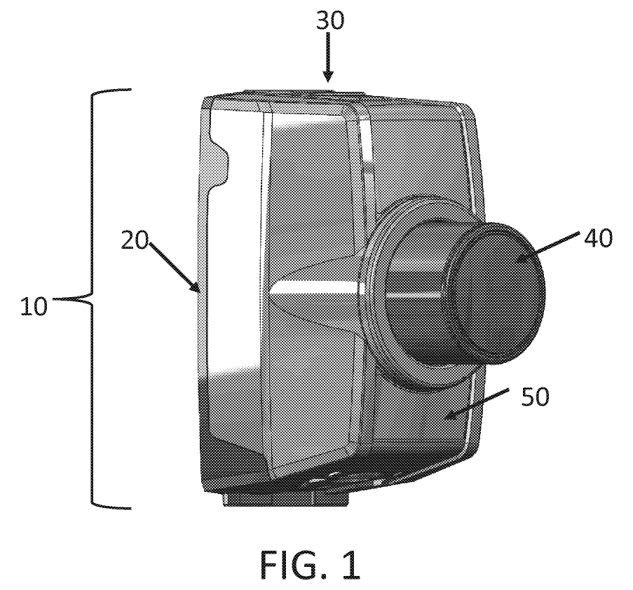

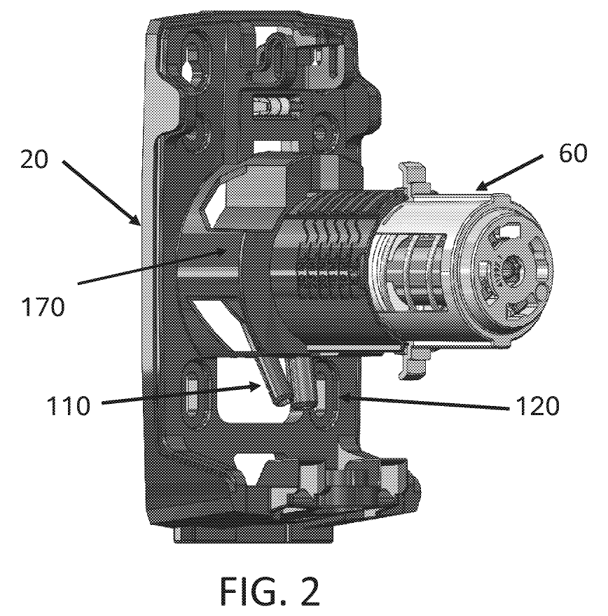

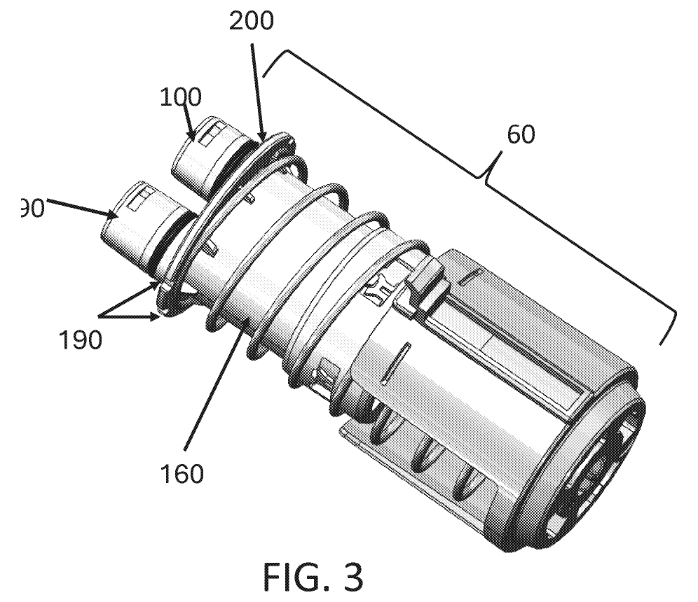

FIGS. 1-5 illustrate an embodiment of a fluid dosing device 10. The device 10 may include a base 20 and a cover assembly 30. The cover assembly 30 may include an activation button 40 and a cover 50. The activation button 40 is configured to actuate a pump assembly 60, as illustrated in FIGS. 2 and 3. In the illustrated embodiment, the activation button 40 may be configured for translational movement, whereby a user depresses the button to actuate the pump assembly 60 to dispense a chemical or other fluid. While the pump assembly 60 referenced in the present disclosure in connection with the included embodiments may be a positive displacement pump, it should be understood that other pump types may also be used in embodiments of the present disclosure.

The cover assembly 30 may be removably securable to the base 20, for example, by tabs or snap ribs or beads on one of the cover assembly 30 or base 20 and corresponding slots or flanges/snap ribs/snap beads on the other of the cover assembly 30 or base 20. In preferred embodiments, the connection structures on the cover assembly 30 and base 20 are configured to be engaged and dis-engaged solely by hand without any need for tools.

FIG. 2 shows the fluid dosing device 10 with the cover assembly 30 removed to more clearly show the base 20 and the pump assembly 60. The base 20 may be affixed to a stationary supporting surface, such as a wall, for example, with screws or other mechanical fasteners inserted through mounting holes in the base 20 and into the stationary surface. However, any suitable permanent or removable mounting method may be used to secure the base 20 to a stationary surface. In the illustrated embodiment, the pump assembly 60 is removably affixed to the base 20.

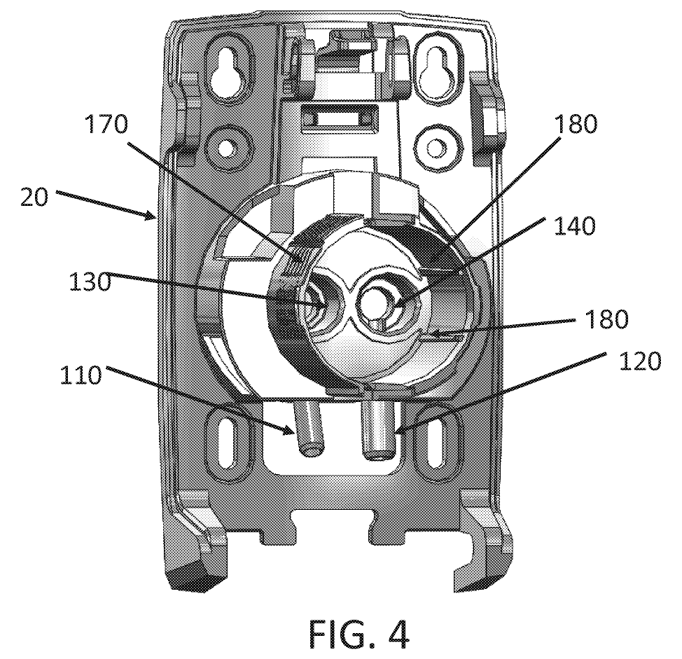

The pump assembly 60 and base 20 are shown in greater detail in FIGS. 3 and 4, respectively. The pump assembly 60 may include a pump inlet 100 and a pump outlet 90. The pump assembly 60 may include a housing, a pumping element, for example, a positive displacement pump, and a manual or automatic actuator, for example, activation button 40 in the illustrated embodiments. The pump assembly 60 draws fluid in through the pump inlet 100 and expels it through the pump outlet 90. The pump assembly 60 may meter the amount of fluid that is expelled from the pump assembly 60, for example, volumetrically, for purposes of maintaining a desired flow rate or dilution ratio.

The base 20 may also be provided with a base inlet 120 and a base outlet 110 that are configured to allow for the flow of fluid into and out of the pump assembly 60. The base inlet 120 is fluidly connected with a chemical source (not shown), for example, a bulk chemical reservoir. The base outlet 110 is fluidly connected with a desired fluid destination (not shown), for example, a machine, such as a ware washer or clothes washer, a diluting system, or another reservoir, such as smaller container that may be used for application of the dispensed fluid. It should be understood that embodiments of the present disclosure are primarily directed to enhancing servicing for the equipment responsible for transmitting a fluid rather than for use with any particular chemical source or destination.

The base 20 may also have an inlet receiver 140 in fluid communication with the base inlet 120 and an outlet receiver 130 in fluid communication with the base outlet 110. During assembly of the fluid dosing device 10, the pump inlet 100 is engage with the inlet receiver 140, for example, by inserting the pump inlet 100 into the inlet receiver 140, and the pump outlet 90 is engaged with the outlet receiver 130, for example, by inserting the pump outlet 90 into the outlet receiver 130, to create and maintain separate fluid flow paths between the base inlet 120 and the pump inlet 100 and between the base outlet 110 and the pump outlet 90.

In some embodiments, the pump inlet 100 and pump outlet 90 may each be provided with different cross-sectional shapes. Similarly, the inlet receiver 140 and the outlet receiver 130 may be provided with different cross-sectional shapes with the inlet receiver 140 and pump inlet 100 sharing the same cross-sectional shape while the outlet receiver 130 and pump outlet 90 share different cross-sectional shape. As a result, only the pump inlet 100 may be fully engaged with, for example, fully inserted into, the inlet receiver 140 and only the pump outlet 90 may be fully engaged with, for example, fully inserted into, the outlet receiver 130. This reduces the likelihood of the inlet/outlet orientation of the pump assembly 60 relative to the base 20 being inadvertently reversed, which may result in leakage and failure of the fluid dosing device 10 and a corresponding loss of fluid and possible contamination of the surrounding space.

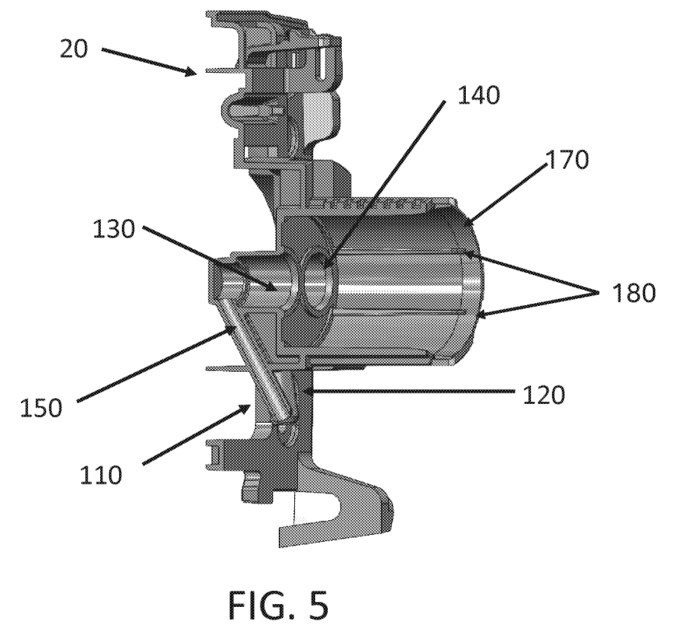

An embodiment of the base 20 is illustrated in FIG. 5 in cross-section to more particularly describe the fluid pathways of the base 20. An outlet conduit passageway 150 may be provided to fluidly connect the outlet receiver 130 with the base outlet 110 such that a direct, linear arrangement of the outlet receiver 130 and the base outlet 110 is not required. While not fully visible in the cross-sectional view of FIG. 5, it may be readily understood that the base 20 may also include an inlet conduit passageway (not shown) to fluidly connect the inlet receiver 140 with the base inlet 120. In embodiments incorporating this or similar arrangements, the conduit passageways between the outlet receiver 130 and the base outlet 110 and between the inlet receiver 140 and the base inlet 120 may advantageously provide for engagement of the pump assembly 60 with the base 20 in a manner that allows for a more compact form for the fluid dosing device 10 while maintaining ready accessibility to the base inlet 120 and base outlet 110 to facilitate connection of hoses, tubing, or other conduits to fluidly connect the base inlet 120 and base outlet 110 with a fluid source and destination, respectively.

In preferred embodiments, the pump assembly 60 is positively secured to and supported by the base 20. The pump assembly 60 may preferably be retained to the base 20 by a selectively releasable coupling or connection, including any suitable removable fastening means, such as, but not limited to, a frictional fit, a snap feature, or a mechanical fastener such as a screw. Preferred embodiments are provided with a manual fastener in which no tools are required to release and engage the fastener to assemble and disassemble the pump assembly and the base. The releasable coupling may be associated with the body 160 of the pump assembly 60 or the engagement of the pump inlet 100 and pump outlet 90 with the inlet receiver 140 and outlet receiver 130. The base 20 may be provided with a mounting collar 170 to accept the body 160 of the pump assembly 60, in which case the releasable coupling may be incorporated into the mounting collar 170 in combination with a corresponding feature on the body 160 of the pump assembly 60.

The pump assembly 60 may be removed from the base 20 by disengaging the releasable coupling, for example, by removing a screw or simply pulling the pump assembly 60 away from the base 20. A replacement pump assembly may then be connected to the base 20 in the same manner by engaging the pump inlet 100 and pump outlet 90 of the replacement pump assembly with the inlet receiver 140 and outlet receiver 130, respectively, and re-engaging the selectively releasable coupling to secure the replacement pump assembly in place on the base 20.

In some embodiments, the base 20, for example, in the mounting collar 170, and the body 160 of the pump assembly 60 may be provided with alignment features. In the embodiment of FIGS. 3 and 4, the alignment features may include one or more alignment ribs 180 on the mounting collar 170 and corresponding alignment slots 190 in the body 160 of the pump assembly 60. In some embodiments, the alignment ribs 180 may be located on an internal surface of the mounting collar and the alignment slots 190 may be located in a flange 200 on the body 160. During installation of a pump assembly 60, the alignment slots 190 of the pump assembly 60 must be lined up with the alignment ribs 180 of the mounting collar 170 before the pump assembly 60 can be fully inserted such that the pump inlet 100 and the pump outlet 90 can engage the inlet receiver 140 and the outlet receiver 130. The alignment slots 190 and the alignment ribs 180 are positioned on the body 160 of the pump assembly 60 and the mounting collar 170 such that alignment of the alignment slots 190 and the alignment ribs 180 results in alignment of the pump inlet 100 with the base inlet 120 or inlet receiver 140 and alignment of the pump outlet 90 with the base outlet 110 or the outlet receiver 130.

In an exemplary embodiment, a method of replacing a pump assembly 60 of the fluid dosing device 10 may include the steps of removing the cover assembly 30 to gain access to the pump assembly 60 if a cover assembly 30 is being used; disengaging the selectively releasable coupling; removing the pump assembly 60 from the base 20; providing a replacement pump assembly also having a pump inlet 100 and a pump outlet 90; fluidly connecting the pump inlet 100 of the replacement pump assembly with the base inlet 120 and fluidly connecting the pump outlet 90 of the replacement pump assembly with the base outlet 110, which may include engaging the pump inlet 100 and the pump outlet 90 of the replacement pump assembly with the inlet receiver 140 and the outlet receiver 130 if the base 20 is provided with those components; and re-engaging the selectively releasable coupling to secure the replacement pump assembly to the base 20. In the case of embodiments in which the base 20 is provided with a mounting collar 170 having one or more alignment ribs 180 and the body 160 of the pump assembly 60 is provided with one or more alignment slots 190, the step of fluidly connecting the pump inlet 100 and pump outlet 90 of the replacement assembly with the base inlet 120 or inlet receiver 140 and the base outlet 110 or outlet receiver 130, respectively, may further include aligning the alignment slots 190 and alignment ribs 180 as the pump assembly 60 is inserted into the mounting collar 170.

It should be noted that the selectively releasable coupling between the base 20 and original and replacement pump assemblies allows for replacement of the pump assembly without removing the base 20 from a supporting surface, for example, a wall. In preferred embodiments in which the selectively releasable coupling includes a tool-free connection, for example a friction fit or snap fit interaction between the pump assembly and the base, the removal of the original pump assembly and installation of the replacement pump assembly is accomplished by an operator or maintenance personnel purely with their hands and without need to have any tools available to conduct the replacement process. wherein the base remains secured to a supporting surface during removal of the pump assembly and installation of the replacement pump assembly.

Embodiments of the present disclosure provide the benefit of a fluid dosing device in which a pump assembly may be quickly and easily replaced with another pump assembly with few or no tools required and without almost no downtime required. These embodiments facilitate pump assembly replacement when a pump assembly fails. Further, they significantly enhance the ability of facility operators and maintenance personnel to implement a regular maintenance system for these pump assemblies to extend their lifetimes and reduce long-term maintenance costs and possible fluid loss and clean up expense due to unexpected pump assembly failure. Embodiments of the present disclosure provide these advantages with minimal lost operating time or additional cost involved.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. A fluid dosing device, comprising:
a surface-mountable base having a base inlet and a base outlet, wherein the base inlet is in fluid communication with a bulk fluid source and the base outlet is in fluid communication with a desired fluid destination;
a pump assembly having a pump inlet and a pump outlet, wherein the pump inlet is configured for selective fluid communication with the base inlet and the pump outlet is configured for selective fluid communication with the base outlet, the pump assembly being configured to draw fluid from the bulk fluid source through the base inlet and into the pump inlet and to expel fluid out of the pump outlet to the base outlet when the pump assembly is engaged with the base; and
a selectively releasable coupling between the base and the pump assembly configured for removal of the pump assembly from the base without removal of the base from a supporting surface of the base.

2. The fluid dosing device of claim 1, wherein the base further comprises an inlet receiver in fluid communication with the base inlet and an outlet receiver in fluid communication with the base outlet;
wherein the inlet receiver is configured to engage the pump inlet to form an inlet fluid path between the pump inlet and the base inlet; and
wherein the outlet receiver is configured to engage the pump outlet to form an outlet fluid path between the pump outlet and the base outlet.

3. The fluid dosing device of claim 2, wherein the base further comprises an outlet conduit passageway fluidly connecting the outlet receiver and the base outlet and an inlet conduit passageway fluidly connecting the inlet receiver and the base inlet.

4. The fluid dosing device of claim 1, wherein the selectively releasable coupling between the base and the pump assembly comprises a manually releasable and engageable fastener.

5. The fluid dosing device of claim 1, wherein the pump assembly further comprises one or more alignment slots and the base further comprises a mounting collar having one or more alignment ribs corresponding to the one or more alignment slots, and wherein the one or more alignment slots are configured on the pump assembly and the one or more alignment ribs are configured on the mounting collar to align the pump inlet with the base inlet and align the pump outlet with the base outlet when the one or more alignment slots are aligned with the one or more alignment ribs.

6. The fluid dosing device of claim 5, wherein the one or more alignment ribs are configured on an internal surface of the mounting collar.

7. The fluid dosing device of claim 2, wherein the pump assembly further comprises one or more alignment slots and the base further comprises a mounting collar having one or more alignment ribs corresponding to the one or more alignment slots, and wherein the one or more alignment slots are configured on the pump assembly and the one or more alignment ribs are configured on the mounting collar to align the pump inlet with the inlet receiver and align the pump outlet with the outlet receiver when the one or more alignment slots are aligned with the one or more alignment ribs.

8. The fluid dosing device of claim 7, wherein the one or more alignment ribs are configured on an internal surface of the mounting collar.

9. The fluid dosing device of claim 1, wherein the base further comprises a mounting collar configured to receive at least a portion of the pump assembly adjacent to the pump inlet and the pump outlet.

10. The fluid dosing device of claim 9, wherein at least one part of the selectively releasable coupling is configured on the mounting collar.

11. The fluid dosing device of claim 2, wherein at least a first part of the selectively releasable coupling is configured on at least one of the pump inlet and the pump outlet and at least a second part of the selectively releasable coupling is configured on at least one of the inlet receiver and the outlet receiver.

12. The fluid dosing device of claim 1, further comprising a cover assembly selectively connectable to the base and configured to enclose the pump assembly.

13. A method of servicing a fluid dosing device, comprising the steps of:
providing a fluid dosing device, comprising:
a surface-mountable base having a base inlet and a base outlet, wherein the base inlet is in fluid communication with a bulk fluid source and the base outlet is in fluid communication with a desired fluid destination;
a pump assembly having a pump inlet and a pump outlet, wherein the pump inlet is in selective fluid communication with the base inlet and the pump outlet is in selective fluid communication with the base outlet, the pump assembly being configured to draw fluid from the bulk fluid source through the base inlet and into the pump inlet an to expel fluid out of the pump outlet to the base outlet when the pump assembly is engaged with the base; and
a selectively releasable coupling between the base and the pump assembly configured for removal of the pump assembly from the base without removal of the base from a supporting surface of the base;
disengaging the selectively releasable coupling;
removing the pump assembly from the base;
providing a replacement pump assembly also having a pump inlet and a pump outlet;
fluidly connecting the pump inlet of the replacement pump assembly with the base inlet and fluidly connecting the pump outlet of the replacement pump assembly with the base outlet;
re-engaging the selectively releasable coupling to secure the replacement pump assembly to the base; and
wherein the base remains secured to a supporting surface during removal of the pump assembly and installation of the replacement pump assembly.

14. The method of servicing a fluid dosing device of claim 5, wherein the base further comprises an inlet receiver in fluid communication with the base inlet and an outlet receiver in fluid communication with the base outlet; and wherein the step of fluidly connecting the pump inlet of the replacement pump assembly with the base inlet and fluidly connecting the pump outlet of the replacement pump assembly with the base outlet further comprises engaging the pump inlet of the replacement pump with the inlet receiver to form an inlet fluid path between the pump inlet and the base inlet and engaging the pump outlet with the outlet receiver to form an outlet fluid path between the pump outlet and the base outlet.

15. The method of servicing a fluid dosing device of claim 13, wherein the fluid dosing device further comprises:
a mounting collar on the base, wherein the mounting collar comprises one or more alignment ribs;
one or more alignment slots on the pump assembly; and
wherein the one or more alignment slots are configured on the pump assembly and the one or more alignment ribs are configured on the mounting collar to align the pump inlet with the base inlet and align the pump outlet with the base outlet when the one or more alignment slots are aligned with the one or more alignment ribs; and
wherein the method further includes the step of aligning the one or more alignment slots with the one or more alignment ribs as the pump assembly is inserted into the mounting collar prior to the step of fluidly connecting the pump inlet of the replacement pump assembly with the base inlet and fluidly connecting the pump outlet of the replacement pump assembly with the base outlet.

16. The method of servicing a fluid dosing device of claim 14, wherein the fluid dosing device further comprises:
a mounting collar on the base, wherein the mounting collar comprises one or more alignment ribs;
one or more alignment slots on the pump assembly; and
wherein the one or more alignment slots are configured on the pump assembly and the one or more alignment ribs are configured on the mounting collar to align the pump inlet with the inlet receiver and align the pump outlet with the outlet receiver when the one or more alignment slots are aligned with the one or more alignment ribs; and
wherein the method further includes the step of aligning the one or more alignment slots with the one or more alignment ribs as the pump assembly is inserted into the mounting collar prior to the step of engaging the pump inlet of the replacement pump with the inlet receiver to form an inlet fluid path between the pump inlet and the base inlet and engaging the pump outlet with the outlet receiver to form an outlet fluid path between the pump outlet and the base outlet.
